(19) United States
(12) Patent Application Publication
(10) Pub. No.: US 2016/0343290 A1
(43) Pub. Date: Nov. 24, 2016

(54) PANEL, TIMING CONTROLLER MODULE AND METHOD FOR SIGNAL ENCODING

(71) Applicant: AU Optronics Corporation, Hsin-Chu (TW)

(72) Inventors: Hung-Chi WANG, Hsin-Chu (TW); Wen-Chiang HUANG, Hsin-Chu (TW)

(21) Appl. No.: 14/824,250

(22) Filed: Aug. 12, 2015

(30) Foreign Application Priority Data
May 20, 2015 (TW) 104116107

(51) Int. Cl. G09G 3/20

(52) U.S. Cl. CPC G09G 3/2092; G09G 2310/06; G09G 2310/08; G09G 2310/0267

(57) ABSTRACT

A panel includes a timing controller module and a source driver module. The timing controller module is for receiving a first display signal encoded with a first encoding method. The first display signal includes a plurality of first symbols. The timing controller module generates a second display signal with a second encoding method according to the first display signal. The second display signal includes a plurality of second symbols. The plurality of second symbols sequentially and one-to-one correspond to the plurality of first symbols sequentially. Each of the plurality of second symbols includes a first bit and a second bit. The first bit and the second bit have different states. The source driver module is coupled to the timing controller module for decoding the second display signal according to the second encoding method. The source driver module generates a third display signal with the first encoding method.

### CROSS-REFERENCE TO RELATED APPLICATIONS

This non-provisional application claims priority under 35 U.S.C. §119(a) on Patent Application No. 104116107 filed in Taiwan, R.O.C on May 20, 2015, the entire contents of which are hereby incorporated by reference.

### BACKGROUND

1. Technical Field

The present disclosure relates to a panel, a timing controller module, and a signal encoding method, particularly to a panel, a timing controller module, and a signal encoding method using minimum run length.

2. Description of the Related Art

As the advancement of technology, the display panel becomes more and more popular in people's daily lives. No matter the smart phones or the vehicle mounted devices with small size panels, or the tablets or the desktops with medium size panels, or even the televisions with large size panels, all kinds of panels are developed towards high-resolution. Moreover, different kinds of multimedia applications including 3D technology increase the data transmission volume of the display panel, so that the data transmission rate is increased accordingly.

However, in practice, the panel signal transmission technology faces the bottleneck because of the advancement of the panel resolution and the data transmission rate. Therefore, how to improve the current panel signal transmission technology to enhance the signal transmission efficiency becomes an urgent problem to the developer.

### SUMMARY

A panel includes a timing controller module and a source driver module. The timing controller module is for receiving a first display signal generated with a first encoding method. The first display signal includes a plurality of first symbols and the timing controller module generates a second display signal with a second encoding method according to the first display signal, wherein the second display signal includes a plurality of second symbols and the plurality of second symbols sequentially and one-to-one correspond to the plurality of first symbols, and each of the plurality of second symbols includes a first bit and a second bit, and the first bit and the second bit have different states. The source driver module is coupled to the timing controller module, and is for generating a third display signal with the first encoding method according to the second display signal to drive the panel, wherein the third display signal includes a plurality of third symbols and the plurality of third symbols sequentially and one-to-one correspond to the plurality of second symbols.

A timing controller module includes a clock and an encoding unit. The clock generating unit is for generating a clock signal. The encoding unit is coupled to the clock generating unit, and is for receiving the clock signal and a first display signal with a first encoding method. The first display signal includes a plurality of first symbols and the encoding unit generates a second display signal with a second encoding method according to the first display signal, wherein the second display signal includes a plurality of second symbols, and the plurality of second symbols sequentially and one-to-one correspond to the plurality of first symbols, and each of the plurality of second symbols includes a first bit and a second bit, and the first bit and the second bit have different states.

A signal encoding method includes generating a clock signal including a plurality of clock cycles, wherein the clock signal includes a clock waveform in each of the plurality of clock cycles and the clock waveform includes a first state and a second state, receiving an input data in each of the plurality of clock cycles, and outputting an output data in each of the plurality of clock cycles according to the input data, wherein the output data and the clock waveform are in the same or opposite phase, and the period of the output data outputted from any two neighboring clock cycles in the first state is not greater than one of the plurality of clock cycles.

The contents of the present disclosure set forth and the embodiments hereinafter are for demonstrating and illustrating the spirit and principles of the present disclosure, and for providing further explanation of the claims.

### BRIEF DESCRIPTION OF THE DRAWINGS

The present disclosure will become more fully understood from the detailed description given hereinbelow and the accompanying drawings, which are given by way of illustration only and thus are not limitative of the present disclosure and wherein:

FIG. 1 is a structural diagram of the panel according to an embodiment;

FIG. 2 is a diagram of the signal time sequence according to an embodiment;

FIG. 3 is a structural diagram of the timing controller module according to an embodiment;

FIG. 4 is a structural diagram of the timing controller module according to another embodiment;

FIG. 5 is a diagram of the time sequence of the signal for explaining the embodiment in FIG. 4;

FIG. 6 is a structural diagram of the timing controller module according to a further embodiment; and

FIG. 7 is a flowchart of the signal encoding method according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

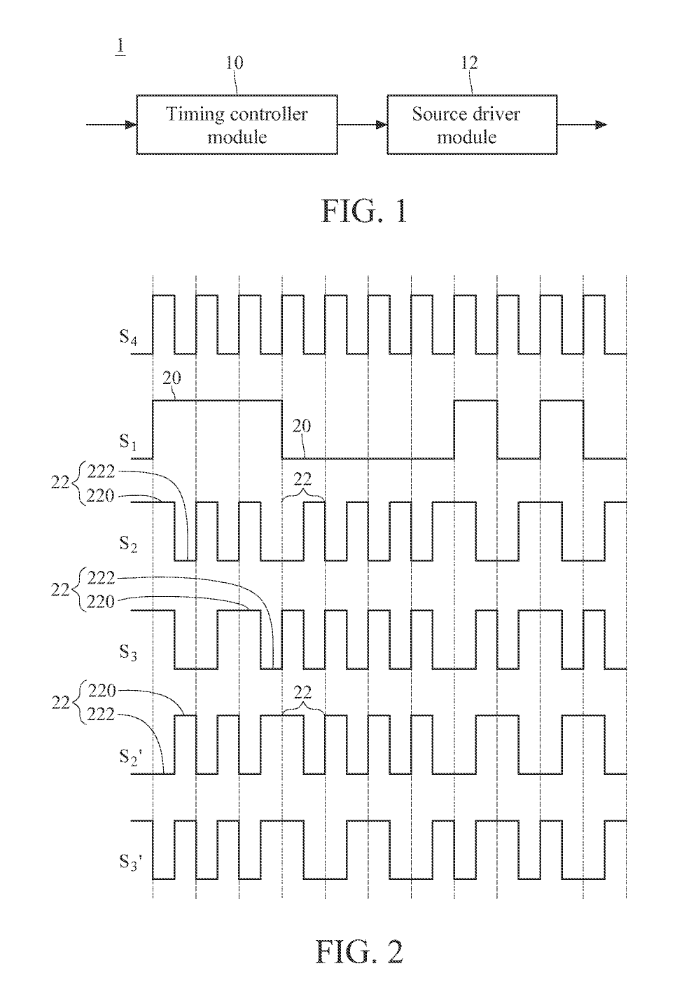

Please refer to FIG. 1. FIG. 1 is a structural diagram of the panel according to an embodiment. As shown in FIG. 1, the panel 1 includes a timing controller module 10 and a source driver module 12. The timing controller module 10 is for receiving a first display signal generated in a first encoding method, and the first display signal includes a plurality of first symbols. In addition, the timing controller module 10 generates a second display signal in a second encoding method according to the first display signal. The second display signal includes a plurality of second symbols and the plurality of second symbols sequentially and one-to-one correspond to the plurality of first symbols. Each of the plurality of second symbols includes a first bit and a second bit, and the first bit and the second bit have different states. The source driver module 12 is coupled to the timing controller module 10 and is for decoding the second display signal according to the second encoding method to generate a third display signal generated in the first encoding method to drive the panel 1. The third display signal includes a plurality of third symbols and the plurality of third symbols sequentially and one-to-one correspond the plurality of second symbols.

Please refer to FIG. 1 and FIG. 2 together for further explanations. FIG. 2 is a diagram of the signal time sequence according to an embodiment. As shown in FIG. 2, the first display signal S1 in every clock cycle of the clock signal S4 includes a first symbol 20, and the first symbol 20 is in the first state or the second state. The timing controller module 10 generates the second display signal S2 with the second encoding method according to the first display signal S1, and the second display signal S2 in every clock cycle of the clock signal S4 includes a second symbol 22. Each second symbol 22 is in one-to-one correspondence to the first symbol 20 according to the time sequence defined by the clock cycle. Each second symbol 22 includes a first bit 220 and a second bit 222, and the first bit 220 and the second bit 222 is in the first state or the second state respectively. In addition, in a second symbol 22, the first bit 220 and the second bit 222 have different states. Moreover, the third display signal decoded by the source driver module 12 is to restore the first display signal S1, so that the characteristics of the third display signal and the first display signal S1 are the same and are not further explained hereinafter. The second display signal S2 generated with the second encoding method changes the state in every clock cycle, so the second display signal S2 has a minimum run length and the maximum value of the minimum run length is 2. In other words, the maximum value of the consecutive bits with the same state of the second display signal S2 is 2.

Please refer to FIG. 2 continuously. In an embodiment, when the first symbol 22 is in the first state, the first bit 220 of the second symbol 22 corresponding to the first symbol 20 is in the first state, and the second bit 222 of the second symbol 22 corresponding to the first symbol 20 is in the second state. When the first symbol 20 is in the second state, the first bit of the second symbol corresponding to the first symbol is in the second state, and the second bit of the second symbol corresponding to the first symbol is in the first state. Taking the second display signal S2 for example, when the first symbol 20 is in the high level state, the first bit 220 is in the high level state and the second bit 222 is in the low level state. When the first symbol 20 is in the low level state, the first bit 220 is in the low level state and the second bit 222 is in the high level state. Taking another second display signal S2′ for example, the order of the first bit 220 and the second bit 222 is exchanged and the variation of the states is the same as the previously described embodiment with the characteristic of minimum run length.

In another embodiment, when the first symbol 20 is in the first state, the first bit 220 of the current second symbol 22 corresponding to the first symbol 20 and the second bit 222 of the previous second symbol neighboring to the current second symbol 22 have the same state. When the first symbol 20 is in the second state, the first bit 220 of the current second symbol 22 corresponding to the first symbol 20 and the second bit 222 of the previous second symbol neighboring to the current second symbol 22 have different states. Taking another second display signal S3 for example, when the first symbol 20, such as the third symbol of the first display signal S1 in FIG. 2, is in the high level state and because the second bit 222 in the previous clock cycle is in the high level state, the first bit 220 in the current clock cycle is in the high level state. When the first symbol 20, such as the fourth symbol of the first display signal S1 in FIG. 2, is in the low level state and because the second bit 222 in the previous clock cycle in the low level state, the first bit 220 in the current clock cycle is in the high level state. Taking the second display signal S3′ as a further example, the definition of the first state and the second state is exchanged, and the variation of the states is the same as the previously described embodiment with the characteristic of minimum run length.

In another embodiment, the second display signal includes a first part and a second part. The first part is for sending the pixel data and the second part is for sending the control data. For example, the pixel data of the first part is encoded with the second encoding method having the characteristic of minimum run length. The second part adopts the hybrid encoding simultaneously including the first encoding method and the second encoding method to define the corresponding training code, horizontal blank code, vertical blank code, data starting code, newline code, and other types of control codes.

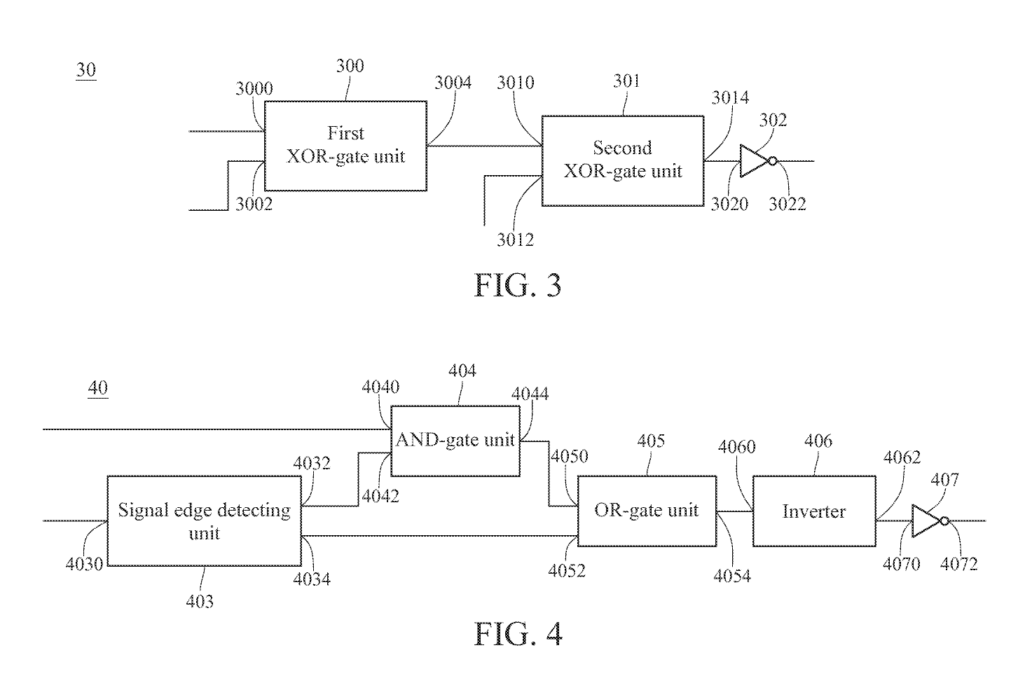

Please refer to FIG. 3. FIG. 3 is a structural diagram of the timing controller module according to an embodiment. As shown in FIG. 3, the timing controller module 30 includes a first XOR-gate unit 300, a second XOR-gate unit 301, and an inverter 302. A first input terminal 3000 of the first XOR-gate unit 300 receives the first display signal and a second input terminal 3002 of the first XOR-gate unit 300 receives the clock signal. A first output terminal 3004 of the first XOR-gate unit 300 is coupled to a third input terminal 3010 of the second XOR-gate unit 301. A fourth input terminal 3012 of the second XOR-gate unit 301 receives the high level signal. A second output terminal 3014 of the second XOR-gate unit 301 is coupled to a fifth input terminal 3020 of the inverter 302. A third output terminal 3022 of the inverter 302 outputs the second display signal.

For example, the first half of a clock cycle waveform of the clock signal is in the high level state and the last half is in the low level state. When the current state is in the first half of the clock cycle waveform and the first display signal is in the high level state, the output of the first XOR-gate unit 300 is in the high level state. Therefore, the output of the second XOR-gate unit 301 is in the high level state, so that the second display signal outputted from the inverter 302 is in the low level state. When the clock signal enters the last half of the clock cycle waveform, the output of the first XOR-gate unit 300 is in the low level state.

Therefore, the output of the second XOR-gate unit 301 is the low level state, so that the second display signal outputted from the inverter 302 is in the high level state. When the first display signal is in the low level state and the clock signal is in the first half of the clock cycle waveform, the output of the first XOR-gate unit 300 is in the low level state. Therefore, the output of the second XOR-gate unit 301 is in the low level state, so that the second display signal outputted from the inverter 302 is in the high level state. Moreover, when the clock signal enters the last half of the clock cycle waveform, the output of the first XOR-gate unit 300 is in the high level state. Therefore, the output of the second XOR-gate unit 301 is in the high level state, so that the second display signal outputted from the inverter 302 is in the low level state.

In another embodiment, the fourth input terminal 3012 of the second XOR-gate unit 301 receives the low level signal. When the clock signal is in the first half of the clock cycle waveform and the first display signal is in the high level state, the output of the first XOR-gate unit 300 is in the high level state. Therefore, the output of the second XOR-gate unit 301 is in the low level state, so that the second display signal outputted from the inverter 302 is in the high level state. When the clock signal enters the last half of the clock cycle waveform, the output of the first XOR-gate unit 300 is in the low level state. Therefore, the output of the second XOR-gate unit 301 is in the high level state, so that the second display signal outputted from the inverter 302 is in the low level state. When the first display signal is in the low level state and the clock signal is in the first half of the clock cycle waveform, the output of the first XOR-gate unit 300 is in the low level state. Therefore, the output of the second XOR-gate unit 301 is in the high level state, so that the second display signal outputted from the inverter 302 is in the low level state. Moreover, when the clock signal enters the last half of the clock cycle waveform, the output of the first XOR-gate unit 300 is in the high level state. Therefore, the output of the second XOR-gate unit 301 is in the low level state, so that the second display signal outputted from the inverter 302 is in the high level state.

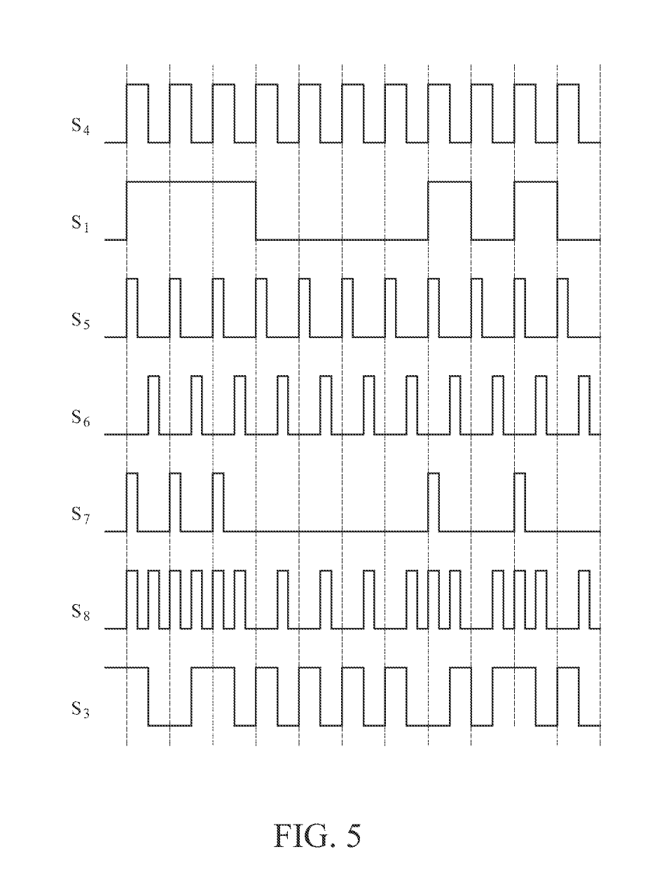

Please refer to FIG. 4. FIG. 4 is a structural diagram of the timing controller module according to another embodiment. As shown in FIG. 4, the timing controller module 40 includes a signal edge detecting unit 403, an AND-gate unit 404, an OR-gate unit 405, a flip-flop 406, and an inverter 407. The first input terminal 4030 of the signal edge detecting unit 403 receives the clock signal. The first output terminal 4032 of the signal edge detecting unit 403 outputs the rising edge detecting signal. The second output terminal 4034 of the signal edge detecting unit 403 outputs the falling edge detecting signal. The second input terminal 4040 of the AND-gate unit 404 receives the first display signal. The third input terminal 4042 of the AND-gate unit 404 is coupled to the first output terminal 4032 of the signal edge detecting unit 403. The fourth input terminal 4050 of the OR-gate unit 405 is coupled to the third output terminal 4044 of the AND-gate unit 404. The fifth input terminal 4052 of the OR-gate unit 405 is coupled to the second output terminal 4034 of the signal edge detecting unit 403. The sixth input terminal 4060 of the flip-flop 406 is coupled to the fourth output terminal 4054 of the OR-gate unit 405. The seventh input terminal 4070 of the inverter 407 is coupled to the fifth output terminal 4062 of the flip-flop 406. The sixth output terminal 4072 of the inverter 407 outputs the second display signal.

Please refer to FIG. 4 and FIG. 5 together. FIG. 5 is a diagram of the time sequence of the signal for explaining the embodiment in FIG. 4. For example, the first half of a clock cycle waveform of the clock signal S4 is in the high level state and the last half is in the low level state. Therefore, the first output terminal 4032 of the signal edge detecting unit 403 outputs the rising edge detecting signal S5 and the second output terminal 4034 of the signal edge detecting unit 403 outputs the falling edge detecting signal S6. When the first display signal S1 is in the high level state, the signal S7 outputted from the third output terminal 4044 of the AND-gate unit 404 in the corresponding clock cycle includes a pulse. In addition, the signal S8 outputted from the fourth output terminal 4054 of the OR-gate unit 405 in the corresponding clock cycle includes two pulses corresponding to the pulse of the rising edge detecting signal S5 and the pulse of the falling edge detecting signal S6 respectively. Therefore, the waveform of the second display signal S3 outputted from the signal S8 after passing the flip-flop 406 and the inverter 407 in the corresponding clock cycle is in the opposite phase to the waveform outputted in the neighboring previous clock cycle. When the first display signal S1 is in the low level state, the signal S7 outputted by the third output terminal 4044 of the AND-gate unit 404 in the corresponding clock cycle is in the low level state. Moreover, the signal S8 outputted by the fourth output terminal 4054 of the OR-gate unit 405 in the corresponding clock cycle includes a pulse and corresponds to the pulse of the falling edge detecting signal S6. Therefore, the waveform of the second display signal S3 outputted from the signal S8 after passing the flip-flop 406 and the inverter 407 in the corresponding clock cycle is in the same phase as the waveform outputted in the neighboring previous clock cycle.

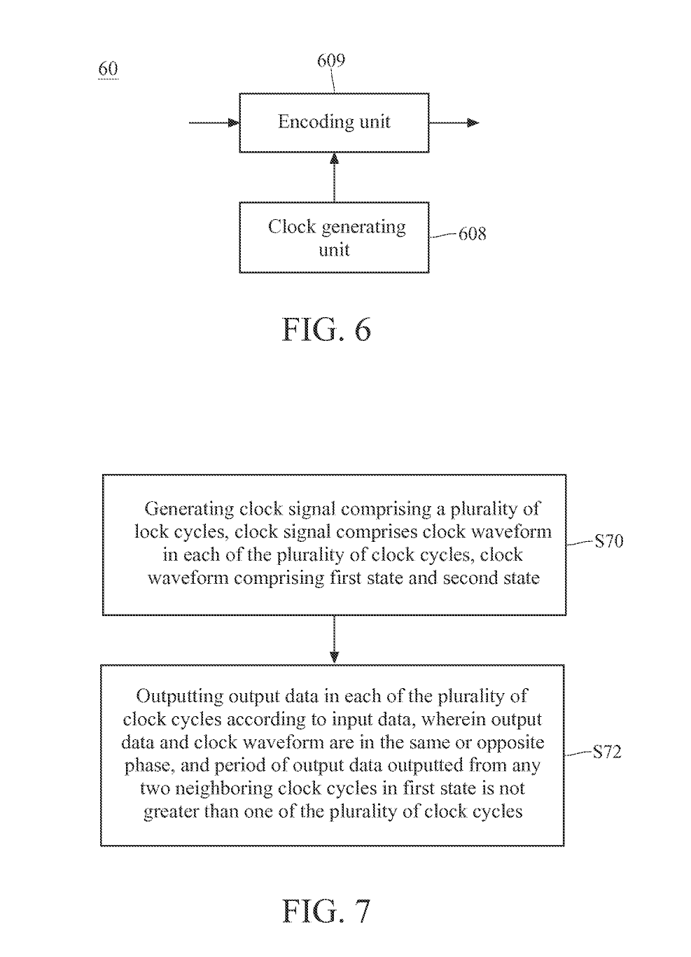

Please refer to FIG. 6. FIG. 6 is a structural diagram of the timing controller module according to a further embodiment. As shown in FIG. 6, the timing controller module 60 includes a clock generating unit 608 and an encoding unit 609. The clock generating unit 608 is for generating the clock signal. The encoding unit 609 is coupled to the clock generating unit 608 and is for receiving the clock signal and the first display signal generated with the first encoding method. The first display signal includes a plurality of first symbols. The encoding unit 609 generates the second display signal with the second encoding method according to the first display signal. The second display signal includes a plurality of second symbols and the plurality of second symbols sequentially and one-to-one correspond to the plurality of first symbols. In addition, each of the plurality of second symbols includes a first bit and a second bit. The first bit and the second bit have different states. The operations and structures of the embodiments related to FIG. 6 are the same as the embodiments in FIG. 2, FIG. 3, FIG. 4, and FIG. 5, and are not further explained hereinafter.

Please refer to FIG. 6 and FIG. 7 together. FIG. 7 is a flowchart of the signal encoding method according to another embodiment. The signal encoding method of the present embodiment is adapted for the timing controller module 60. As shown in FIG. 7, in the step S70, the clock generating unit 608 generates the clock signal, and the clock signal includes a plurality of clock cycles, and each of the plurality of clock cycles includes a clock waveform. In addition, each of the plurality of clock waveforms includes a first state and a second state. In the step S72, the encoding unit 609 outputs the output data in every clock cycle, and the output data and the clock waveform are in the same or opposite phase. The period of the output data in the first state outputted from any two neighboring clock cycles is no greater than a clock cycle.

In an embodiment, the step S72 includes the following steps. When the input data is in the first state, the encoding unit 609 outputs the output data having the same phase as the clock waveform. When the input data is in the second state, the encoding unit 609 outputs the output data having the opposite phase to the clock waveform. In another embodiment, the step S72 includes the following steps. When the input data is in the first state and the input data received in the previous clock cycle is in the first state, the encoding unit 609 outputs the output data having the opposite phase to the output data outputted in the previous clock cycle. When the input data is in the first state and the input data received in the previous clock cycle is in the second state, the encoding unit 609 outputs the output data having the same phase as the output data outputted in the previous clock cycle. The specific details are explained in the embodiment in FIG. 2 and are not further described hereinafter.

In another embodiment, the input data includes the first symbol, and the clock waveform includes the second symbol, and the second symbol includes the first bit and the second bit, and the first bit includes the first state, and the second bit includes the second state. The step S72 includes the following steps. When the first symbol is in the first state, the encoding unit 609 outputs the output data. The first bit of the output data is in the first state and the second bit of the output data is in the second state. When the first symbol is in the second state, the encoding unit 609 outputs the output data. The first bit of the output data is in the second state and the second bit of the output data is in the first state. In another embodiment, the step S72 includes the following steps. When the first symbol is in the first state, the encoding unit 609 outputs the output data. The first bit of the output data and the second bit of the output data outputted in the previous clock cycle have the same state. Moreover, when the first symbol is in the second state, the encoding unit 609 outputs the output data. The first bit of the output data and the second bit of the output data outputted in the previous clock cycle have different states. The specific details are explained in the embodiment in FIG. 2 and are not further described hereinafter.

An encoding method with minimum run length for signal transmission is adopted between the time sequence control device and the source driving device of the panel, so that the purpose of balancing direct current is achieved, and the error rate of the signal data is also reduced, and the signal transmission efficiency is enhanced accordingly. In addition, the decoding circuit disclosed in the embodiments has a simple structure and low cost. Furthermore, the encoding method having the self-clock also increases the efficiency of clock capturing. Therefore, better signal transmission effect is achieved and the display quality is enhanced.

The foregoing description has been presented for purposes of illustration. It is not exhaustive and does not limit the disclosure to the precise forms or embodiments disclosed. Modifications and adaptations will be apparent to those skilled in the art from consideration of the specification and practice of the disclosed embodiments of the disclosure. It is intended, therefore, that the specification and examples be considered as exemplary only, with a true scope and spirit of the disclosure being indicated by the following claims and their full scope of equivalents.

What is claimed is:

1. A panel, comprising:
a timing controller module for receiving a first display signal generated with a first encoding method, the first display signal comprising a plurality of first symbols and the timing controller module generating a second display signal with a second encoding method according to the first display signal, wherein the second display signal comprises a plurality of second symbols and the plurality of second symbols sequentially and one-to-one correspond to the plurality of first symbols, and each of the plurality of second symbols comprises a first bit and a second bit, and the first bit and the second bit have different states; and
a source driver module coupled to the timing controller module, for generating a third display signal with the first encoding method according to the second display signal to drive the panel, wherein the third display signal comprises a plurality of third symbols and the plurality of third symbols sequentially and one-to-one correspond to the plurality of second symbols.

2. The panel of claim 1, wherein when the first symbol is in a first state, the first bit of the second symbol corresponding to the first symbol is in the first state and the second bit of the second symbol corresponding to the first symbol is in a second state, and when the first symbol is in the second state, the first bit of the second symbol corresponding to the first symbol is in the second state and the second bit of the second symbol corresponding to the first symbol is in the first state.

3. The panel of claim 1, wherein when the first symbol is in a first state, the first bit of the current second symbol corresponding to the first symbol and the second bit of the previous second symbol neighboring to the current second symbol have the same state, and when the first symbol is in a second state, the first bit of the current second symbol corresponding to the first symbol and the second bit of the previous second symbol neighboring to the current second symbol have different states.

4. The panel of claim 1, wherein the second display signal comprises a first part and a second part, and the first part is for sending a pixel data, and the second part is for sending a control data.

5. The panel of claim 1, wherein the timing controller module comprises a first XOR-gate unit, a second XOR-gate unit, and an inverter, and a first input terminal of the first XOR-gate unit receives the first display signal, and a second input terminal of the first XOR-gate unit receives a clock signal, and a first output terminal of the first XOR-gate unit is coupled to a third input terminal of the second XOR-gate unit, and a fourth input terminal of the second XOR-gate unit receives a high level signal, and a second output terminal of the second XOR-gate unit is coupled to a fifth input terminal of the inverter, and a third output terminal of the inverter outputs the second display signal.

6. The panel of claim 1, wherein the timing controller module comprises a signal edge detecting unit, an AND-gate unit, an OR-gate unit, a flip-flop, and an inverter, and a first input terminal of the signal edge detecting unit receives a clock signal, and a first output terminal of the signal edge detecting unit outputs a rising edge detecting signal, and a second output terminal of the signal edge detecting unit outputs a falling edge detecting signal, and a second input terminal of the AND-gate unit receives the first display signal, and a fourth input terminal of the OR-gate unit is coupled to a third output terminal of the AND-gate unit, and a fifth input terminal of the OR-gate unit is coupled to the second output terminal of the signal edge detecting unit, and a sixth input terminal of the flip-flop is coupled to a fourth output terminal of the OR-gate unit, and a seventh input terminal of the inverter is coupled to a fifth output terminal of the flip-flop, and a sixth output terminal of the inverter outputs the second display signal.

7. The panel of claim 1, wherein the timing controller module comprises:
a clock generating unit for generating a clock signal; and
an encoding unit coupled to the clock generating unit, for generating the second display signal with the second encoding method according to the clock signal and the first display signal.

8. A timing controller module, comprising:
a clock generating unit for generating a clock signal; and
an encoding unit coupled to the clock generating unit, for receiving the clock signal and a first display signal with a first encoding method, the first display signal comprising a plurality of first symbols, the encoding unit generating a second display signal with a second encoding method according to the first display signal, wherein the second display signal comprising a plurality of second symbols, and the plurality of second symbols sequentially and one-to-one correspond to the plurality of first symbols, and each of the plurality of second symbols comprises a first bit and a second bit, and the first bit and the second bit have different states.

9. The timing controller module of claim 8, wherein when the first symbol is in a first state, the first bit of the second symbol corresponding to the first symbol is in the first state and the second bit of the second symbol corresponding to the first symbol is in a second state, and when the first symbol is in the second state, the first bit of the second symbol corresponding to the first symbol is in the second state and the second bit of the second symbol corresponding to the first symbol is in the first state.

10. The timing controller module of claim 8, wherein when the first symbol is in a first state, the first bit of the current second symbol corresponding to the first symbol and the second bit of the previous second symbol neighboring to the current second symbol have the same state, and when the first symbol is in a second state, the first bit of the current second symbol corresponding to the first symbol and the second bit of the previous second symbol neighboring to the current second symbol have different states.

11. The timing controller module of claim 8, wherein the second display signal comprises a first part and a second part, and the first part is for sending a pixel data, and the second part is for sending a control data.

12. The timing controller module of claim 8, wherein the timing controller module comprises a first XOR-gate unit, a second XOR-gate unit, and an inverter, and a first input terminal of the first XOR-gate unit receives the first display signal, and a second input terminal of the first XOR-gate unit receives a clock signal, and a first output terminal of the first XOR-gate unit is coupled to a third input terminal of the second XOR-gate unit, and a fourth input terminal of the second XOR-gate unit receives a high level signal, and a second output terminal of the second XOR-gate unit is coupled to a fifth input terminal of the inverter, and a third output terminal of the inverter outputs the second display signal.

13. The timing controller module of claim 8, wherein the timing controller module comprises a signal edge detecting unit, an AND-gate unit, an OR-gate unit, a flip-flop, and an inverter, and a first input terminal of the signal edge detecting unit receives a clock signal, and a first output terminal of the signal edge detecting unit outputs a rising edge detecting signal, and a second output terminal of the signal edge detecting unit outputs a falling edge detecting signal, and a second input terminal of the AND-gate unit receives the first display signal, and a fourth input terminal of the OR-gate unit is coupled to a third output terminal of the AND-gate unit, and a fifth input terminal of the OR-gate unit is coupled to the second output terminal of the signal edge detecting unit, and a sixth input terminal of the flip-flop is coupled to a fourth output terminal of the OR-gate unit, and a seventh input terminal of the inverter is coupled to a fifth output terminal of the flip-flop, and a sixth output terminal of the inverter outputs the second display signal.

14. A signal encoding method, comprising:
generating a clock signal comprising a plurality of clock cycles, the clock signal comprises a clock waveform in each of the plurality of clock cycles, the clock waveform comprising a first state and a second state;
receiving an input data in each of the plurality of clock cycles; and
outputting an output data in each of the plurality of clock cycles according to the input data, wherein the output data and the clock waveform are in the same or opposite phase, and the period of the output data outputted from any two neighboring clock cycles in the first state is not greater than one of the plurality of clock cycles.

15. The signal encoding method of claim 14, wherein the step of outputting the output data comprises:
when the input data is in the first state, outputting the output data in the same phase as the clock waveform; and
when the input data is in the second state, outputting the output data in the opposite phase to the clock waveform.

16. The signal encoding method of claim 14, wherein the step of outputting the output data comprising:
when the input data is in the first state and the input data received in the previous clock cycle is in the first state, outputting the output data in the opposite phase to the input data received in the previous clock cycle; and
when the input data is in the first state and the input data received in the previous clock cycle is in the second state, outputting the output data in the same phase as the input data received in the previous clock cycle.

17. The signal encoding method of claim 14, wherein the input data comprises a first symbol and the clock waveform comprises a second symbol and the second symbol comprises a first bit and a second bit and the first bit is in the first state and the second bit is in the second state, and the step of outputting the output data comprises:
outputting the output data when the first symbol is in the first state, wherein the first bit of the output data is in the first state and the second bit of the output data is in the second state; and
outputting the output data when the first symbol is in the second state, wherein the first bit of the output data is in the second state and the second bit of the output data is in the first state.

18. The signal encoding method of claim 14, wherein the input data comprises a first symbol and the clock waveform comprises a second symbol and the second symbol comprises a first bit and a second bit and the first bit is in the first state and the second bit is in the second state, and the step of outputting the output data comprises:
outputting the output data when the first symbol is in the first state, wherein the first bit of the output data and the second bit of the output data outputted in the previous clock cycle have the same state; and
outputting the output data when the first symbol is in the second state, wherein the first bit of the output data and the second bit of the output data outputted in the previous clock cycle have different states.
